(19) United States
(12) Patent Application Publication
(10) Pub. No.: US 2007/0174129 A1
(43) Pub. Date: Jul. 26, 2007

(54) System and method for ordering of goods and services with alternative payment

(76) Inventors: Ralph Muniz, Union City, NJ (US); Shevin Conway, Secaucus, NJ (US)

Correspondence Address: Esteban A. Rockett, 267-A Alpine Way, Woodbridge, NJ, 07095, US

(21) Appl. No.: 11/173,423

(22) Filed: Jul. 1, 2005

Related U.S. Application Data
(60) Provisional application No. 60/584,669, filed on Jul. 1, 2004.

(51) Int. Cl. G06Q 30/00

(52) U.S. Cl. 705/26

(57) ABSTRACT

A system and method for providing on-line purchases of Internet and retail goods or services by people with no credit cards, using existing infrastructure, is disclosed. The present system and method allows a person with no credit cards to order a good or service being offered for sale, by having the order queued at a service provider. In accordance with an exemplary embodiment of the present invention, the order is completed (purchase) after the person with no credit cards transmits the payment for the order to the service provider, within a pre-determined time frame.

### CROSS REFERENCE TO RELATED APPLICATION

The instant application claims priority to U.S. Provisional Patent Application No. 60/584,669, filed Jul. 1, 2004, which is further incorporated by reference in its entity herein.

### FIELD OF THE INVENTION

The present invention relates to goods and services ordered on-line. More specifically, the present invention relates to payment for goods and services ordered on-line.

### BACKGROUND OF THE INVENTION

For decades there has been a segment of the population comprising people who do not have active credit to utilize for purchases (“No-Credit Person” or “NCP”). Some of these NCPs do not have credit cards due to previous negative credit history, preventing them from acquiring new active credit cards. Other NCPs do not have the appropriate credentials to apply and receive credit. Other NCPs simply do not wish to use credit cards due to their phobias, such as identity theft, credit card fraud, etc. In addition to not having credit cards, many NCPs do not have bank accounts. NCPs often are employed with average to above average wage earning jobs. Further, NCPs are often large quantity consumers, their purchases being solely cash-based.

With the advent of the Internet many people make purchases for all types of goods and/or services on-line, from conventional physical goods, such as electronics; virtual goods, such as music downloads; conventional services, such as airline tickets; and virtual services, such as web hosting, e-mail accounts, etc. via the Internet (“Internet GS”). The above purchases typically require the purchaser to secure the above-recited goods or services with a credit card of some type. Even services such as PAYPAL require at least a bank account and credit card for identity verification, neither of which are commonly owned by NCPs, nor are most NCPs interested in being listed in such a database . (PAYPAL typically has other purchase restrictions as well.)

Hence, NCPs, even though they may have (and usually have) the physical cash to purchase Internet GS, NCPs do not have a means, e.g., credit card, to actually purchase Internet GS. This is problematic in at least two regards. First, NCPs do not have access to goods and services and/or discounted or otherwise preferential pricing only available on the Internet. Second, merchants are not able to avail their Internet GS to these NCPs, thereby preventing such merchants from realizing their full revenue stream.

What is needed is an efficient system and method, using existing infrastructure, for on-line purchases of Internet GS by NCPs.

### SUMMARY OF INVENTION

An object of the present invention is to provide a system and method which allows NCPs to purchase Internet GS on the Internet; and additionally to have the ability to make purchases that would traditionally require a credit card, bank account or other identifying property to the NCPs, whether via the Internet, retail store, mail order, telephone order, or any other avenue used to purchase goods and/or services.

In order to achieve this objective, as well as others which will become apparent in the disclosure below, in a first exemplary embodiment, the present invention provides for a system and method which allows a NCP, on their initial use of the system and method (“Guest”), to purchase Internet GS on the Internet.

In this first exemplary embodiment of the present invention, the Guest orders an Internet GS, either (i) on with a host website of the service provider of the present system and method featuring Internet GS across all participating merchants (“CNG Service Provider”) or (ii) initiates an order on an actual merchant's website (traditional on-line order). The Guest does not need to identify themselves, but is given a unique identifier for the order they initiated (“CNG Number”). The CNG Number is a unique reference for the Guest's order. The Guest is then given a pre-determined period of time, e.g., 0-48 hours, to transfer the purchase price, plus a transaction fee (“CNG Transaction Fee”), to the CNG Service Provider via a variety of accepted (or future) cash transfer systems, e.g., MONEYGRAM, WESTERN UNION, PAY-O-MATIC. Upon receipt of the purchase price and CNG Transaction Fee, the CNG Service Provider completes the purchase for the GUEST and delivery the Internet GS.

A second exemplary embodiment of the present invention provides for a system and method which allows a NCP with an account with the CNG Service Provider (“CNG User”) three (3) alternative purchase options to purchase Internet GS on the Internet.

In accordance with this second exemplary embodiment of the present invention, a CNG User, has three option (i) order Internet GS like a Guest and perfect the transaction in 0-48 hours by transfer of the purchase price and CNG Transaction Fee to the CNG Service Provider, (ii) if the CNG User has previously deposited at least 50%, but less than 99%, of the purchase price of the Internet GS in their CNG account (coupled with an evaluation of the CNG User's past history of payment and usage of the system described herein). the CNG Service Provider will complete the purchase upon the order from a CNG User, delivery of the Internet GS being held until the CNG User transfers the balance of the purchase price plus CNG Transaction Fee to the CNG Service Provider, or (iii) if the CNG User has previously deposited 100% of the purchase price and CNG Transaction Fee in their CNG account, the CNG Service Provider will complete the purchase upon the order from a CNG User and initiate immediate delivery of the Internet GS.

Thus, the present system and method provides for on-line purchases of Internet GS by NCPs, using existing infrastructure, without the use of a credit card.

### BRIEF DESCRIPTION OF THE DRAWINGS

For a complete understanding of the present invention and the advantages thereof, reference is now made to the following description taken in conjunction with the accompanying drawings in which like reference numbers indicate like features, components and method steps, and wherein:

FIG. 1 is a flow diagram showing the basic process flow for on-line purchases of Internet GS by Guests to the CNG Service Provider in accordance with the first exemplary embodiment of the present invention;

FIG. 2 is a flow diagram showing the basic process flow for on-line purchases of Internet GS by CNG Users in accordance with the first exemplary embodiment of the present invention; and

FIG. 3 is an illustration of a system for on-line purchases of Internet GS by CNG Users or Guests of the CNG Service Provider in accordance with the present invention.

### DESCRIPTION OF A PRESENTLY PREFERRED EMBODIMENT

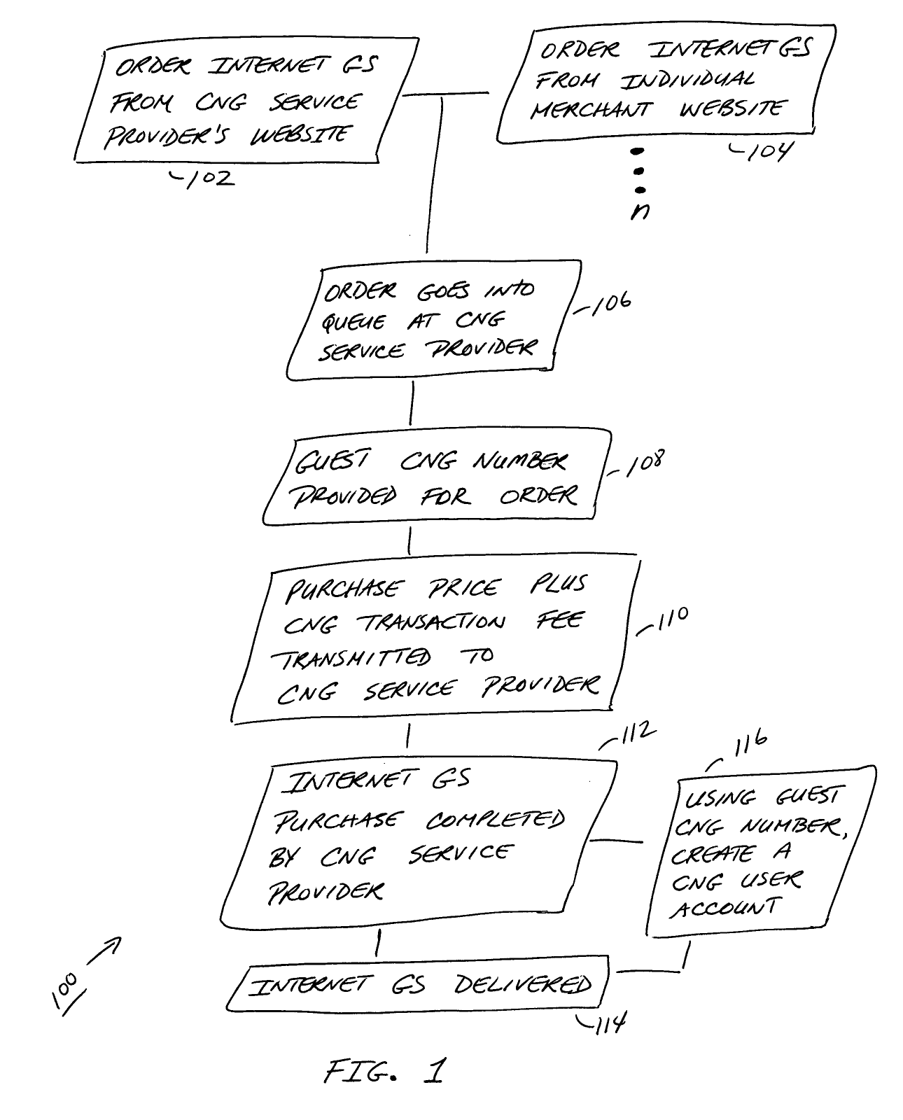

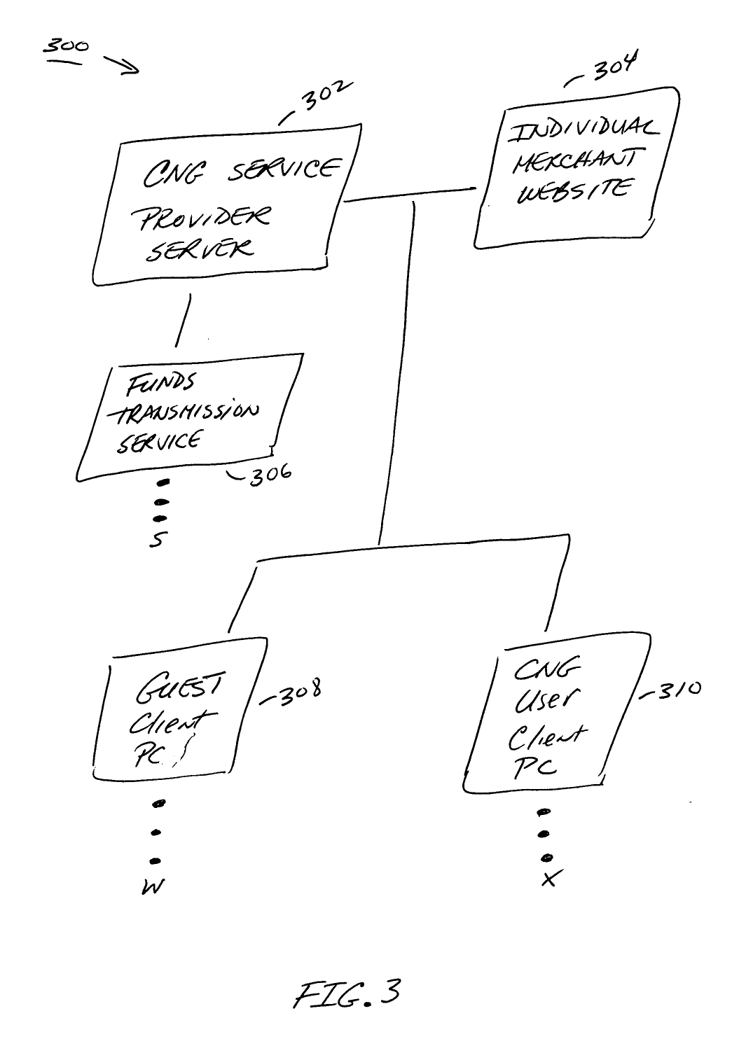

The below detailed description of preferred embodiments is described with reference to on-line/Internet ordering solely for easy of explanation. Applicants' present invention, as described below, equally applies to any purchase that would traditionally require a credit card, bank account or other identifying property to the NCPs, whether via the Internet, retail store, mail order, telephone order, or any other avenue (currently known or developed in the future) used to purchase goods and/or services. Hence, the system and method of the present invention is not intended to be restricted to only Internet or on-line use, but rather to encompass the scope of all purchasing. Referring to FIG. 1, process flow 100 is shown. Process Flow 100 is a method for on-line purchases of Internet GS by Guests to the CNG Service Provider in accordance with a first exemplary embodiment of the present invention. First, a Guest orders an Internet GS from either (i) the CNG Service Provider's website, in step 102, or (ii) individual merchant website, in step 104. In the latter case, the CNG Service Provider provides an individual merchant (client) with any necessary links, cookies, etc, for order processing, originating on the individual merchant's website and passed to the CNG Service Provider of processing and payment receipt. Whether originated from step 102 or 104, the order then goes into a queue at the CNG Service Provider, in step 106. In accordance with this first exemplary embodiment of the present invention, the Internet GS is not actually purchased by the CNG Service Provider at this point. Next, the Guest is provided with a unique Guest CNG Number for the order, in step 108. The Guest then has a pre-determined time frame to transmit the purchase price plus a CNG Transaction Fee to the CNG Service Provider, in step 110. The Guest can use pre-existing systems for the cash transmission of the purchase price and CNG Transaction Fee. Such pre-existing systems for cash transmission include WESTERN UNION, MONEYGRAM, PAY-O-MATIC, or equivalent current or future systems which allow an individual to transfer funds using cash. Further, the CNG Service Provider itself may opt to provide retail store operation(s) or kiosk(s) (“CNG Physical Locations”), where the CNG Service Provider may receive and process the cash transmissions directly from the Guest (or CNG User (see below)). Such CNG Physical Locations can also be expanded to receive delivery of goods, to eliminate the need for the Guest (or CNG User) to provide an address (in the case of goods that need to be delivered.) (See step 110 below.) FIG. 3 provides a system diagram which further exemplifies this transfer. The pre-determined time frame is preferably 0-48 hours from the order initiation time/date. Please note that 0-48 hours is simply a preferred time frame, however, such time frame may be any range as pre-determined by the CNG Service Provider. Further, alternative to a CNG Transaction Fee, the CNG Service Provider can alternatively select to charge the actual merchants a fee for the transaction, as in conventional VISA and MASTERCARD transactions; or a hybrid fee such as partitioning the fee between the Guest and merchant. The CNG Service Provider completes the purchase of the ordered Internet GS after receiving the purchase price and CNG Transaction Fee from the Guest within the pre-determined time period, in step 112. The CNG Service Provider then delivers the Internet GS to the Guest, in step 114. If the Internet GS is of the type that needs to be delivered to a physical address, the Guest will be prompted to provide such an address, preferably, at step 110. Further any time after step 112, the Guest will be invited to created a CNG User Account, in step 116, where name, deliver information, etc., is maintained by the CNG Service Provider. Further, a CNG User may carry a positive balance in their CNG User Account for use in the second embodiment of the present invention, as described below.

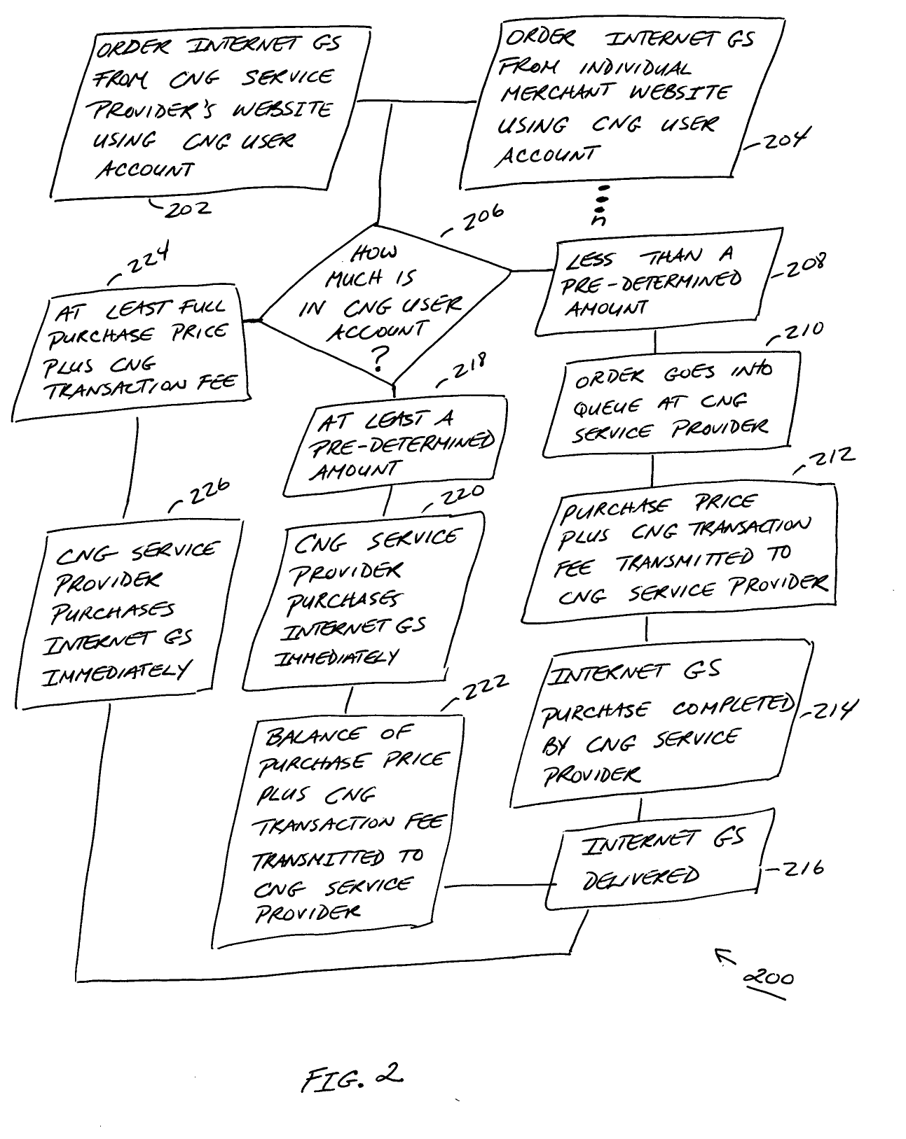

Referring to FIG. 2, process flow 200 is shown. Process Flow 200 is a method for on-line purchases of Internet GS by CNG User Account holders in accordance with a second exemplary embodiment of the present invention. First, a CNG User orders an Internet GS from either (i) the CNG Service Provider's website, in step 202, or (ii) individual merchant website, in step 204. In the latter case, the CNG Service Provider provides an individual merchant with any necessary links, cookies, etc, for order processing originating on the individual merchant's website and passed to the CNG Service Provider of processing and payment receipt. Whether originated from step 202 or 204, the order's processing is determined after the CNG Service Provider determines the quantity of funds, if any, in the CNG User's Account, in step 206. If the quantity of funds in the CNG User's Account is less than a pre-determined amount, in step 208, the order then goes into a queue at the CNG Service Provider, in step 210. The pre-determined amount is preferably at least 50%, but less than 99%, of the purchase price (coupled with an evaluation of the CNG User's past history of payment and usage of the system described herein). In accordance with this first exemplary embodiment of the present invention, the Internet GS is not actually purchased by the CNG Service Provider at this point. The CNG User then has a pre-determined time frame to transmit the purchase price plus a CNG Transaction Fee to the CNG Service Provider, in step 212. The CNG User can use pre-existing systems for the cash transmission of the purchase price and CNG Transaction Fee. Such pre-existing system for cash transmission include WESTERN UNION, MONEYGRAM, PAY-O-MATIC, or equivalent current or future system which allow an individual to transfer funds using cash. Again, FIG. 3 provides a system diagram which further exemplifies this transfer. The pre-determined time frame is preferably 0-48 hours from the order initiation time/date. Again, please note that 0-48 hours is simply a preferred time frame, however, such time frame may be any range as pre-determined by the CNG Service Provider. Further, alternative to a CNG Transaction Fee, the CNG Service Provider can alternatively select to charge the actual merchants a fee for the transaction, as in conventional VISA and MASTERCARD transactions; or a hybrid fee such as partitioning the fee between the CNG User and merchant. The CNG Service Provider completes the purchase of the ordered Internet GS after receiving the purchase price and CNG Transaction Fee from the CNG USER within the pre-determined time period, in step 214. The CNG Service Provider then delivers the Internet GS to the CNG User, in step 216.

If the CNG User has at least the pre-determined amount in its account, in step 218, then the CNG Service Provider purchases the Internet GS immediately for the CNG User, in step 220. However, delivery is held until the CNG User transmits the balance of the purchase price plus CNG transaction fee to the CNG Service Provider in the pre-determined time frame, in step 222. Again, alternative to a CNG Transaction Fee, the CNG Service Provider can alternatively select to charge the actual merchants a fee for the transaction, as in conventional VISA and MASTERCARD transactions; or a hybrid fee such as partitioning the fee between the CNG User and merchant. The CNG Service Provider then delivers the Internet GS to the CNG User, in step 216.

If the CNG User has at least the full amount of the purchase price of the Internet GS ordered, plus the CNG Transaction Fee (if applicable), in their CNG User Account, in step 224, then the CNG Service Provider purchases the Internet GS immediately for the CNG User, in step 226. Again, alternative to a CNG Transaction Fee, the CNG Service Provider can alternatively select to charge the actual merchants a fee for the transaction, as in conventional VISA and MASTERCARD transactions; or a hybrid fee such as partitioning the fee between the CNG User and merchant. The CNG Service Provider then delivers the Internet GS to the CNG User, in step 216.

In addition, since the CNG Service Provider, itself, is on the Internet, the CNG Service Provider may provide order tracking of order processing, by means of the CNG Number, for Guests; and CNG User ID, for CNG Users (as defined above), respectively.

Thus, the present system and method provides for on-line purchases of Internet GS by CNG Users or Guests of the CNG Service Provider in accordance with the present invention.

Although the invention has been described herein by reference to an exemplary embodiment thereof, it will be understood that such embodiment is susceptible of modification and variation without departing from the inventive concepts disclosed. For example, the CNG Service Provider can create hybrid systems to better integrate the system and method of the present invention, for example, the ability to hold airline reservation directly on the reservation system of an airline company until the Guest or CNG User transmits the applicable funds. Similar, the present invention can be used to book hotel and car rental reservations. All such modifications and variations, therefore, are intended to be encompassed within the spirit and scope of the appended claims.

We claim:

1. A system for purchasing good or service, said system comprising:
a payment service provider, said payment service provider receiving an order for a good or service, said payment service provider holding purchase of said good or service of said order, said hold comprising:
waiting until funds for said order are received within a pre-determined time frame; and
a funds transmission service, said finds transmission service receiving funds for said order and transmitting said funds to said payment service provider.

2. The system of claim 1 further comprising at least one of a merchant website, said merchant website providing at least one good or service where an order for said good or service is processed by said payment service provider; a payment service provider website, said payment provider website providing at least one good or service where an order for said good or service is processed by said payment service provider; a retail store, said retail store accepting payment for at least one good or service from said payment service provider; a mail order service, said mail order service accepting payment for at least one good or service from said payment service provider; and a telephone order service, said telephone order service accepting payment for at least one good or service from said payment service provider and.

3. The system of claim 1, wherein said funds transmission service receives cash for said transmitting.

4. The system of claim 3, wherein said funds transmission service comprises at least one of Western Union, Money Gram, Pay-O-Matic, or said payment service provider.

5. The system of claim 1, where said pre-determined time frame is within a range of 0 to 48 hours.

6. A method for purchasing of a good or service, said method comprising:
ordering a good or service;
placing said order in a queue;
receiving payment for said order within a pre-determined time frame; and
completing purchase of said order.

7. The method of claim 6 further comprising the step of delivering said order after the step of completing purchase of said order.

8. The method of claim 6 further comprising the step of providing a unique order identifier after said order is placed into said queue.

9. The method of claim 6, wherein said purchased is completed for said good or service if at least a pre-determined amount is in an account.

10. The method of claim 9, wherein said pre-determined amount is within a range of 50% to 99% of said payment.

11. The method of claim 6, wherein said purchased and delivery of said good or service is completed upon order if at least said payment is in an account.

12. The method of claim 11, wherein said pre-determined amount is 100% of said payment.

13. The method of claim 6, wherein said pre-determined time frame is within a range if 0 to 48 hours.
